(19) United States
(12) Patent Application Publication
(10) Pub. No.: US 2017/0030563 A1
(43) Pub. Date: Feb. 2, 2017

(54) RETROFITTING SYSTEM FOR POLE MOUNTED LIGHT FIXTURES

(71) Applicant: Atlas Lighting Products, Inc., Burlington, NC (US)

(72) Inventors: R. Samuel Hunt, Burlington, NC (US); James H. Bennett, Greensboro, NC (US); Scott T. Ellingson, Graham, NC (US); Cheng S. Chang, Elon, NC (US); Nathan D. Congdon, Graham, NC (US)

(21) Appl. No.: 15/219,929

(22) Filed: Jul. 26, 2016

Related U.S. Application Data
(60) Provisional application No. 62/199,491, filed on Jul. 31, 2015.

(51) Int. Cl. F21V 21/116; F21V 23/00; F21K 9/20; F21S 8/08

(52) U.S. Cl. CPC F21V 21/116; F21S 8/088; F21V 23/002; F21K 9/20; F21Y 2115/10

(57) ABSTRACT

A system and method for retrofitting an existing light pole. The system includes at least one LED light fixture, at least one connector, and an adaptor configured to be mounted to the top of the existing light pole. The adaptor is a first adaptor when the existing light pole has a round base and no tenon. The adaptor is a second adaptor when the existing light pole has a round base and a tenon. The adaptor is a third adaptor when the existing light pole has a square base and a tenon. The first adaptor, the second adaptor, and the third adaptor each have a different configuration.

### FIELD OF DISCLOSURE

The present disclosure relates to exterior illumination such as lighting of parking lots. More particularly, the present disclosure relates to mounts for positioning light fixtures upon poles for illuminating such an outdoor environment.

### BACKGROUND

In many areas of the country, shopping centers, schools, and workplaces have all been built with adjacent surface parking lots to accommodate the cars and trucks driven by employees and shoppers. To enhance safety and security, almost all surface parking lots are illuminated at night with wide area light fixtures, most often supported above the ground atop light poles. The light poles may be securely fixed to the ground through concrete bases or dug deep into the ground. Current light poles are used in two principal cross-sections: round and square. Light poles are also in use having a variety of heights and diameters. Many existing light poles have been constructed with a tenon protruding from the top of the pole to accommodate brackets which allow for a plurality of light fixtures to be supported by a single pole.

FIG. 1 illustrates a pair of prior art light fixtures 1 mounted on an existing pole 3 via a bracket 5 that attaches to a tenon 7 extending from the distal top end of the pole 3. The tenon 7 is hollow to allow wiring to pass from the pole 3 toward the light fixtures 1.

The light fixtures 1 currently in use above many parking lots are aging, requiring more and more maintenance, often from specialized contractors with the correct equipment to reach the fixtures located well above the ground. Further, these fixtures 1 emit light generated by inefficient sources such as metal halide and high pressure sodium lamps.

There is a growing need for the ability to replace broken or outdated fixtures with highly energy efficient LED based area light fixtures while both reusing as much infrastructure as possible and providing for quick and straight forward installation.

### SUMMARY

The present disclosure includes a system for retrofitting an existing light pole. The system includes at least one LED light fixture, at least one connector, and an adaptor configured to be mounted to the top of the existing light pole. The adaptor is a first adaptor when the existing light pole has a round base and no tenon. The adaptor is a second adaptor when the existing light pole has a round base and a tenon. The adaptor is a third adaptor when the existing light pole has a square base and a tenon. The first adaptor, the second adaptor, and the third adaptor each have a different configuration.

The present disclosure also includes an adaptor for mounting at least one light fixture upon a pole, the adaptor comprising a tube having an interior surface, an exterior surface, and a longitudinal axis extending along the length of the tube. The adaptor also includes a stopper bracket mounted on the interior surface of the tube, the stopper bracket including an annular portion disposed with an opening of the annular portion substantially perpendicular to the longitudinal axis. The annular portion is disposed along the longitudinal axis to abut a distal end of the existing light pole. At least one first wiring aperture may be provided through the tube at a position above the annular portion.

The present disclosure also includes a method of retrofitting a light pole. The method may include removing any existing light fixture, selecting a first adaptor when the light pole comprises a round base and no tenon, selecting a second adaptor when the light pole comprises a round base and a tenon, and selecting a third adaptor when the light pole comprises a square base and a tenon. The method may also include mounting the selected adaptor of the first, second and third adaptors to the top of the light pole and installing an LED light fixture upon the selected adaptor.

These and other aspects of the present invention will become apparent to those skilled in the art after a reading of the following description of the preferred embodiments, when considered in conjunction with the drawings. It should be understood that both the foregoing general description and the following detailed description are explanatory only and are not restrictive of the invention as claimed.

### BRIEF DESCRIPTION OF THE DRAWINGS

FIG. 1 is a parking lot with support structure and light fixtures known in the art.

FIG. 2 is a perspective view of a retrofit light pole according to embodiments of the present disclosure.

FIG. 3 is an exploded view of FIG. 2.

FIG. 4 is a cross sectional view of a portion of the retrofit light pole of FIG. 2.

FIGS. 5A-5G are several views of an alternative adaptor for retrofitting a light pole.

FIGS. 6A-6G are several views of another alternative adaptor for retrofitting a light pole.

### DETAILED DESCRIPTION

Exemplary embodiments of this disclosure are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention. Features from one embodiment or aspect may be combined with features from any other embodiment or aspect in any appropriate combination. For example, any individual or collective features of method aspects or embodiments may be applied to apparatus, product or component aspects or embodiments and vice versa.

This disclosure provides a system for retrofitting an existing light pole. Inventors have recognized the value associated with being able to retrofit preexisting light poles to accept new fixtures, particularly energy efficient light emitting diode (LED) light fixtures. First, light poles may be expensive simply because of the amount of material necessary to provide the desired distance from the ground to the light fixtures. More importantly, existing light poles are generally secured permanently to the ground, often with concrete footings or dug deep into the ground. Removing an existing pole to put up a new one would generally be a very labor intensive process, again producing a further barrier to the installation of more energy efficient light fixtures.

In addition to recognizing the benefits of retrofitting existing light poles, inventors have also recognized that the retrofitting process is not consistent among all poles because of the wide variety of shapes and sizes of poles currently in use. Therefore, inventors have developed a system with a minimum number of distinct adaptors to maximize the number of pole sizes and configurations that will accommodate a new light fixture. One goal of the disclosed system is to minimize the number of poles through which drilling holes is required to convert from an existing fixture, which may have been made from a first manufacturer, to an energy efficient fixture, which may have been made by a second manufacturer. Inventors need not eliminate the need to drill holes in existing poles completely, but have recognized the difficultly of accurately drilling holes well above the ground, through a pole, especially through round poles with small (e.g. less than 3.5 inches) diameters near the top. If holes are not accurately drilled, fixtures may not hang level, and each fixture on the pole may be at a slightly different height.

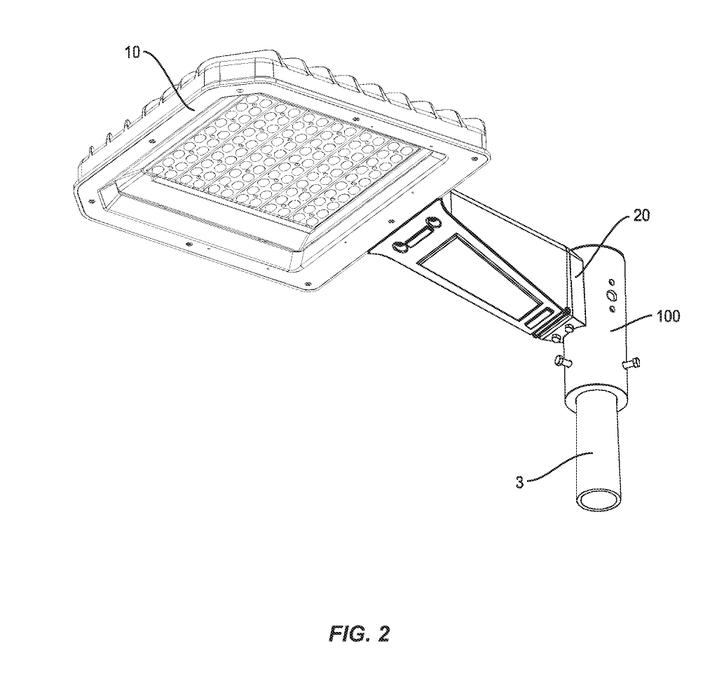

FIG. 2 shows the top portion of an existing pole 3, particularly a round pole of less than about 3.5 inches in diameter at the top, which has been retrofit with a system according to embodiments of the present disclosure. The system includes at least one light fixture 10. In many cases, several light fixtures 10 may be mounted to a single pole 3 depending upon the light distribution pattern and brightness desired. The light fixture 10 may be an energy efficient light fixture, such as a fixture that emits light by powering light emitting diodes (LEDs). The light fixture 10 may be referred to as an area light based upon its distribution and expected use well above parking lots or similar outdoor areas.

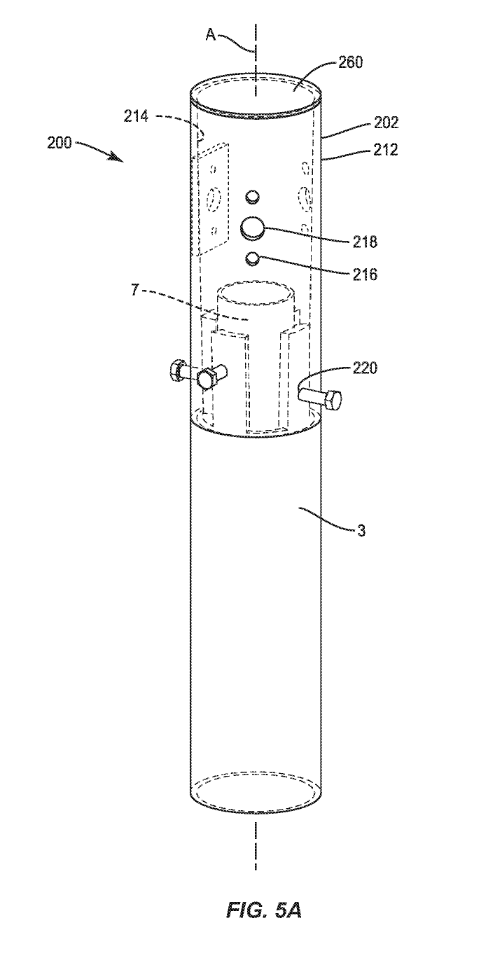

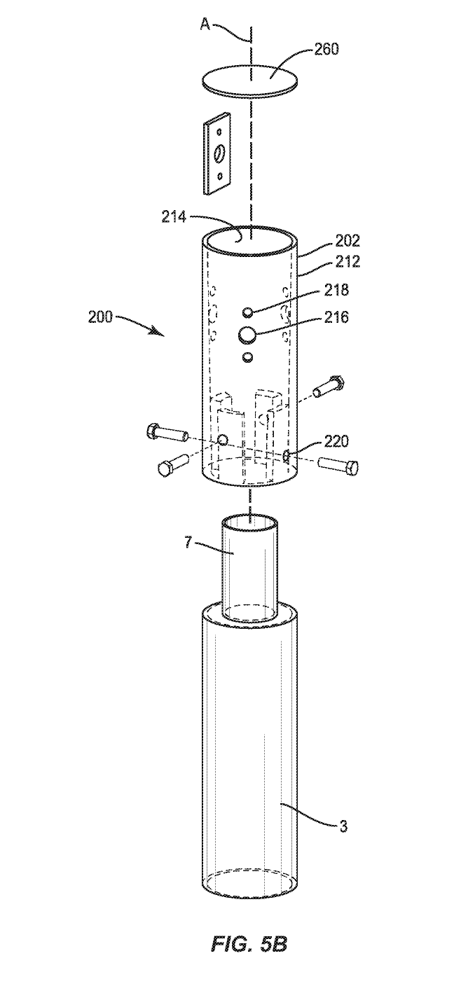

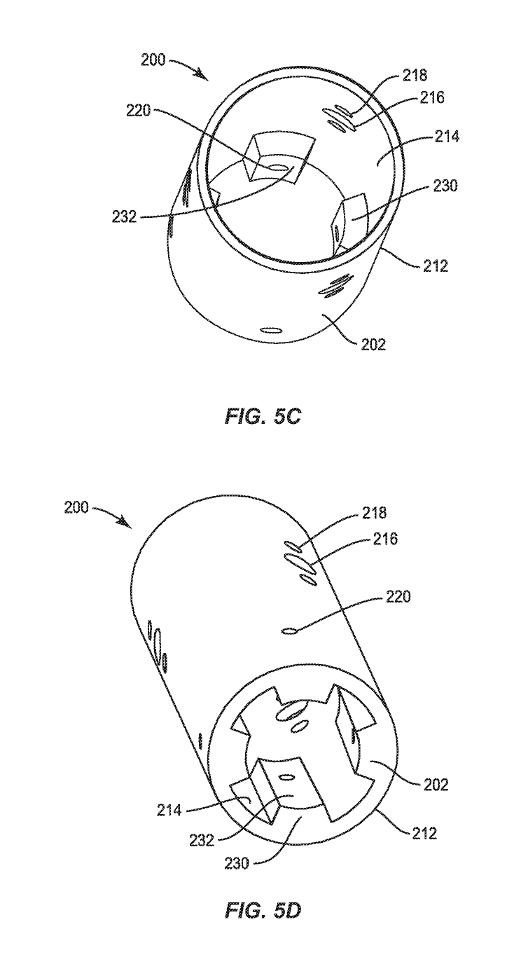

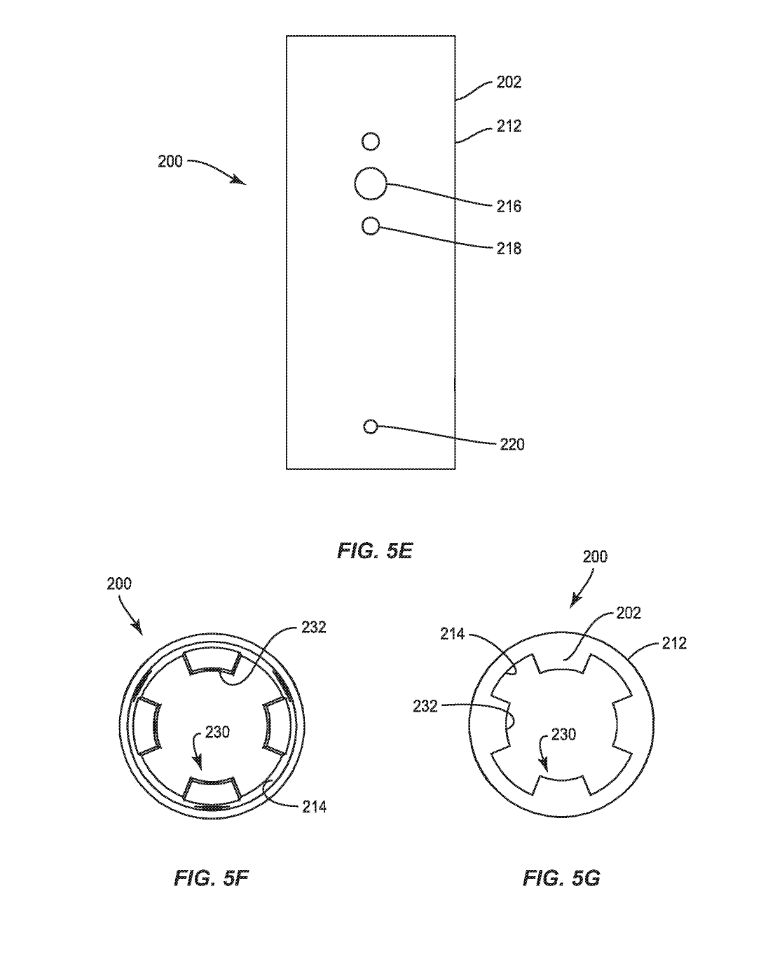

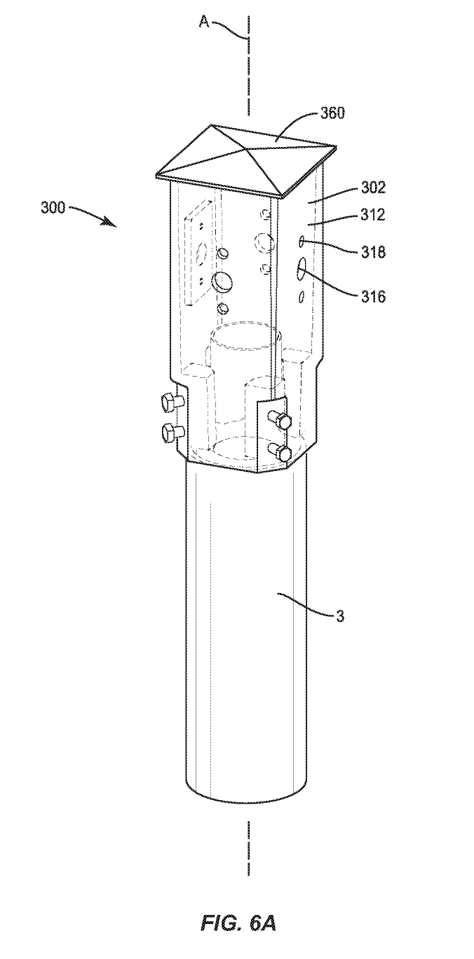

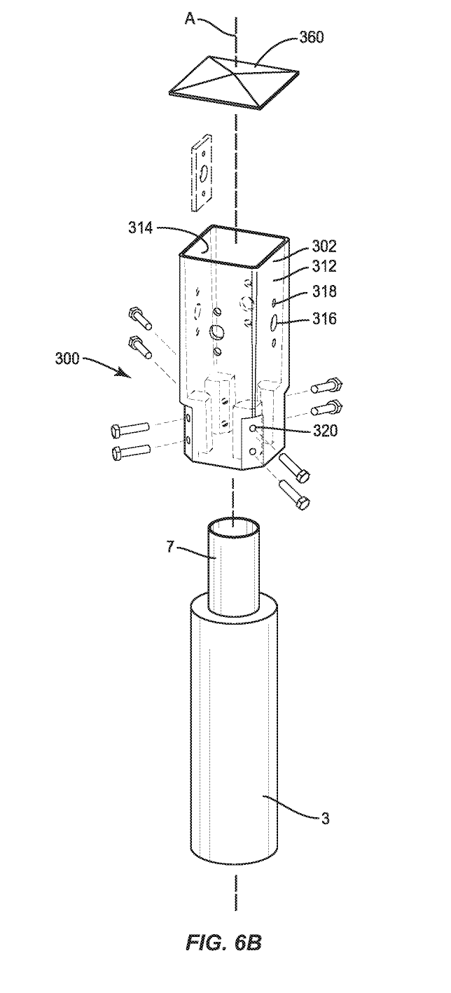

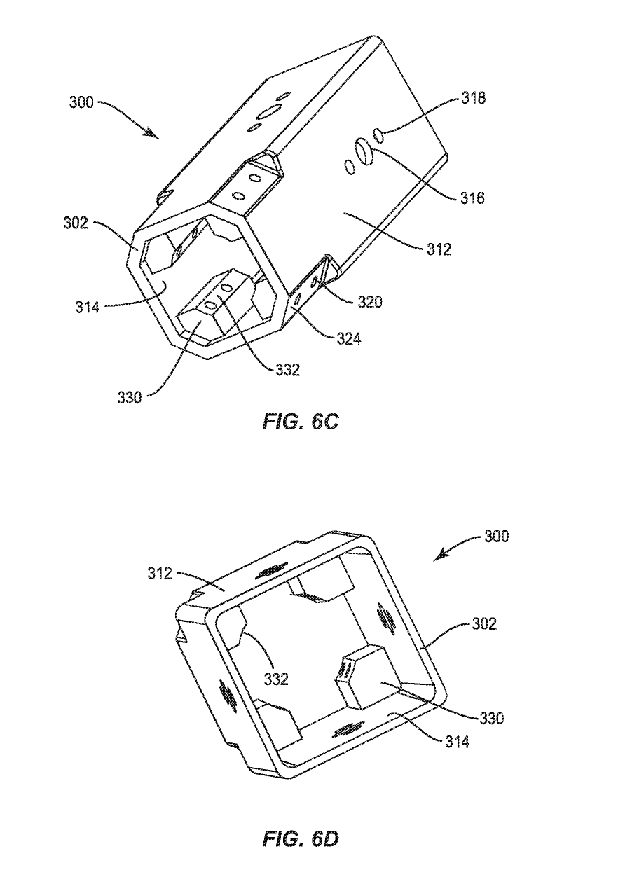

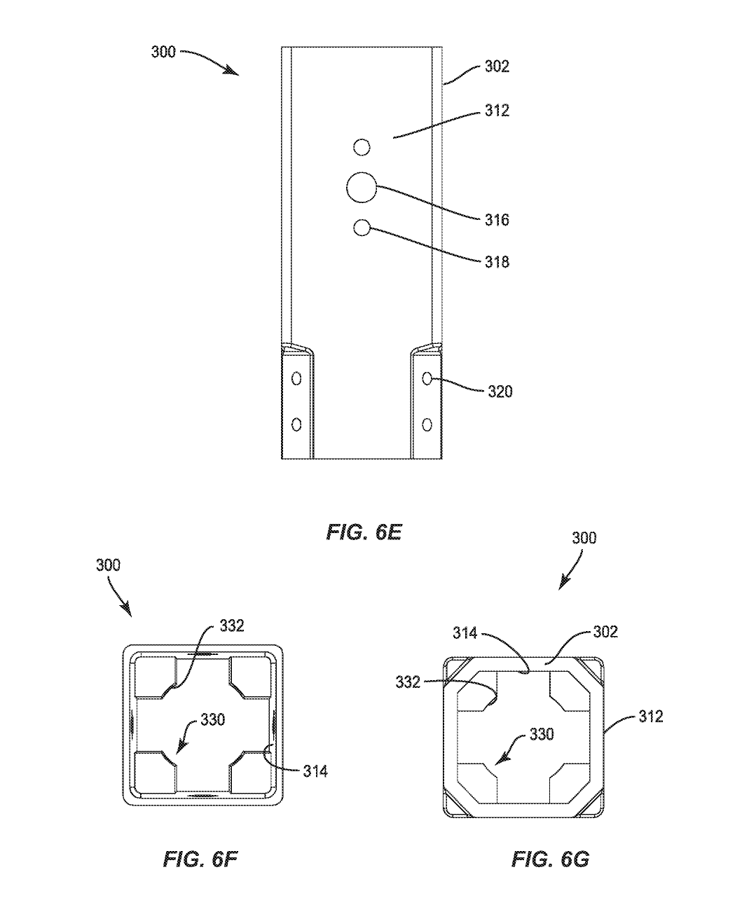

The system may further comprise a first adaptor 100 configured to be mounted to the top of the existing pole 3. The system may include at least one connector 20 for joining the light fixture 10 to the first adaptor 100. In order to accommodate several sizes and configurations of poles 3, the system allows for selection among at least the first adaptor 100 and a second adaptor 200 (see FIG. 5A), and possibly a third adaptor 300 (see FIG. 6A).

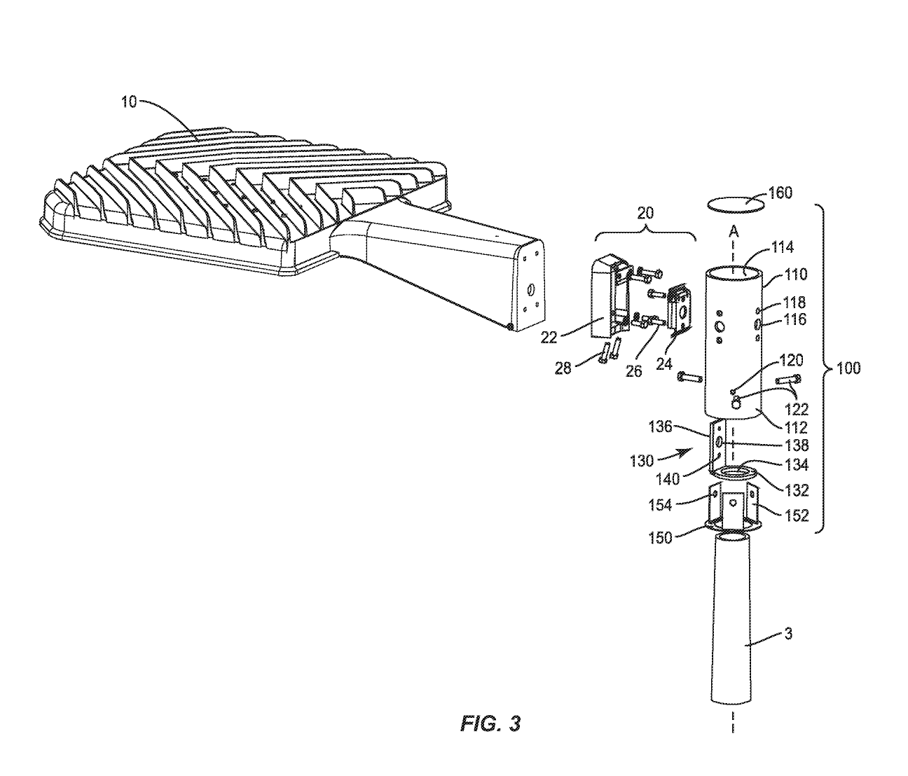

FIG. 3 is an exploded view of the pole 3 shown in FIG. 2. The connector 20 may include a junction 22 configured to be fixed to the light fixture 10. The configuration of the junction 22 may be selected based upon the shape of the pole 3 or the adaptor 100, 200, 300. The connector 20 may also include a mounting bracket 24 to be fastened to the adaptor 100, 200, 300 by fasteners 26, such as bolts. The junction 22 may engage the mounting bracket 24 to hang the light fixture 10 from the pole 3. Securing the junction 22 to the mounting bracket 24 may include one or more screws 28.

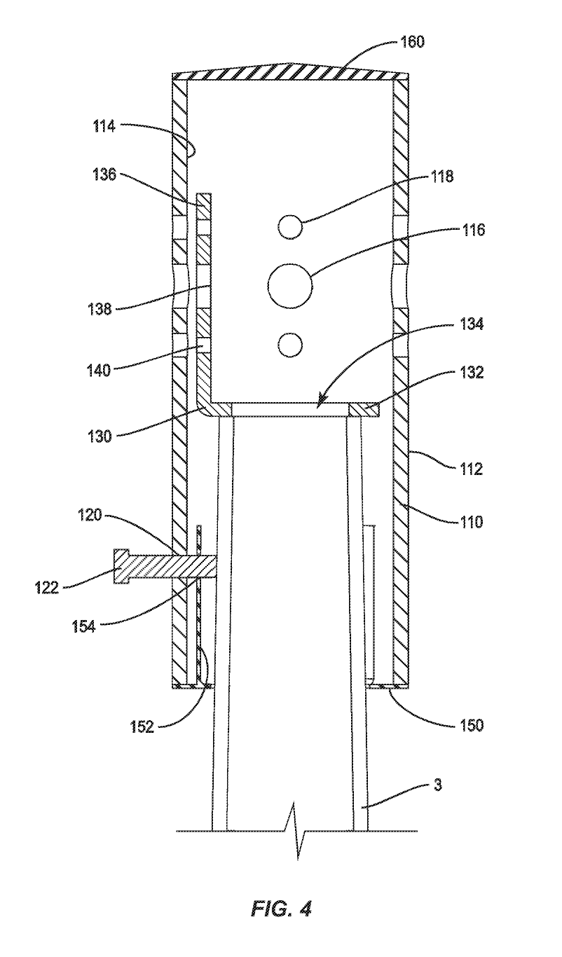

The first adaptor 100 is shown further in FIGS. 3 and 4. The system is designed so that the first adaptor 100 is intended to be used on a round pole. The first adaptor 100, however may fit around some square profile poles, though the round shape of the first adaptor 100 may clash with a square pole. The first adaptor 100 is also designed for round poles whose diameter at the top may be too small to accommodate the desired light fixture 10 or connector 20, such as a pole 3 with a top outer diameter of about 3.5 inches or less.

Generally, the first adaptor 100 is not expected for placement upon a standard tenon 7. Second and third adaptors 200, 300 may be better suited for placement upon the tenon 7, as discussed below. The first adaptor 100, however, may be secured to a pole 3 with a conventional tenon 7.

The first adaptor 100 is exploded in FIG. 3 to show a tube 110, a stopper bracket 130, and an optional bottom cover 150. The tube 110, stopper bracket 130 and optional bottom cover 150 are illustrated as separate components that may be arranged together. In other embodiments, these elements may be integrated with one another into a unitary construction. The tube 110 may be a cylindrical, i.e. round, tube having an exterior surface 112, an interior surface 114 and a longitudinal axis A extending in the length direction of the tube 110. The tube 110 may have one or more first wiring apertures 116 provided through the tube 110 at a position above the distal end of the post 3, as shown in FIG. 4. Each first wiring aperture 116 is intended for use to pass wiring from within the pole 3, through each first wiring aperture 116 for use of the wires to provide power to respective light fixtures 10. The tube 110 may be provided with a single first wiring aperture 116, a pair disposed 180 degrees apart, a set of three spaced 120 degrees apart, a set of four spaced 90 degrees apart, etc. One or more first bracket apertures 118 may be associated with each first wiring aperture 116 to mount a respective mounting bracket 24 to the tube 110 at one or more of the first wiring apertures 116. The tube 110 may have one or more spaced apart first mounting apertures 120 configured to receive set screws 122 that extend through the first mounting apertures 120 and contact the pole 3 to secure the first adaptor 100 to the pole 3.

The stopper bracket 130 may be mounted on the interior surface 114 of the tube 110. The stopper bracket 130 may include an annular portion 132 disposed with an opening 134 of the annular portion substantially perpendicular to the longitudinal axis A. As seen in FIG. 4, the annular portion 132 is disposed along the longitudinal axis A to abut a distal end of the existing light pole 3, thereby providing a stop surface. The stopper bracket 130 may include an attachment portion 136 extending from the annular portion 132 substantially parallel with the longitudinal axis A. The attachment portion 136 may be used to connect the stopper bracket 130 to the tube 110. The attachment portion 136 may have a second wiring aperture 138 and one or more second bracket apertures 140. The second wiring aperture 138 and the second bracket aperture 140 are configured to be aligned with the first wiring aperture 116 and a corresponding first bracket aperture 118 respectively.

An optional bottom cover 150 may be provided on the bottom of the tube 110 to cover a gap between the interior surface 114 of the tube 110 and an outer diameter of the existing pole 3. Projections 152 may extend upward from the bottom cover 150 to provide mounting portions that may have second mounting apertures 154 configured to align with a corresponding first mounting aperture 120 such that the set screw 122 also maintains the bottom cover 150 relative to the tube 110.

The first adaptor 100 may include, or may be separately provided with a cap 160 that snap fits into the top of the tube 110 to substantially prevent water from passing into the pole 3 through the adaptor 100. Any of the first wiring apertures 116, first bracket apertures 118 and first mounting apertures 120 that are unused may also be provided with buttons to fill each exposed opening.

FIGS. 5A-G show several views of a second adaptor 200. According to the system of the present disclosure, the second adaptor 200 having a different configuration from the first adaptor 100 may be preferred when the existing light pole 3 has a round base and is provided with a tenon 7 projecting from the distal end thereof. FIG. 5A shows a partially transparent view of the second adaptor 200 positioned on the tenon 7. FIG. 5B presents an exploded view. FIGS. 5C-5G are a top perspective, bottom perspective, front view, top view and bottom view respectively of a body 202 of the second adaptor 200. In the illustrated embodiment, the second adaptor 200 is cast from a strong lightweight material, such as aluminum, into a generally hollow unitary body 202. Like the first adaptor 100, the second adaptor 200 may have a longitudinal axis A passing through the second adaptor along the length thereof. The body 202 forms a peripheral wall having an exterior surface 212 and an interior surface 214. The peripheral wall may be understood as being substantially cylindrical such that a profile of the exterior surface 212 is circular (i.e. round) to mirror the outside of a round pole 3.

The second adaptor 200 may have several features similar to the first adaptor 100, including at least one wiring aperture 216, at least one bracket aperture 218, and at least one mounting aperture 220. The at least one wiring aperture 216 may be formed through the body 202 and configured as a conduit for passing wiring from the pole 3 to the light fixture 10. In one embodiment, the second adaptor 200 comprises three wiring apertures 216 spaced at 120 degree intervals around the longitudinal axis A. The at least one bracket aperture 218 may be formed adjacent to a respective wiring aperture 216 for use when securing a mounting bracket 24 to the second adaptor 200. The at least one mounting aperture 220 may be formed through the peripheral wall and configured to receive a set screw 222 to secure the second adaptor 200 to the tenon 7. Further, a cap 260 may be provided on the top of the body 202.

The interior surface 214 of the second adaptor 200 is configured specifically to provide a close fit over a standard tenon 7 that is 2 and ⅜ inches in outside diameter. A close fit is provided when the interior surface 214 is capable of sliding closely over a standard 2 and ⅜ inch tenon 7 with minimal clearance. As a result, the longitudinal axis A is maintained parallel with a longitudinal axis of the pole 3 when the second adaptor 200 is fully seated on the tenon 7 as a force is applied to the sides of the second adaptor 200. Collectively, the interior surfaces 214 may be curved to follow a circle, providing an interior diameter of 2 and ½ inches. In this embodiment, a close fit with minimal clearance works out to be about 1/16 inch on each side. As shown in FIGS. 5A-5G, the body 202 of the embodiment shown has a plurality of protrusions 230 extending inwardly from the peripheral wall to form the portion of the interior surface 214 that provides the close fit over the tenon 7. In some embodiments, the protrusions 230 do not extend a full length of the body 202. In some embodiments, an interior face 232 of each protrusion 230 is curved.

FIGS. 6A-G show several views of a third adaptor 300. According to the system of the present disclosure, the third adaptor 300 having a different configuration from the first and second adaptors 100, 200 may be preferred when the existing light pole 3 has a substantially square profile and is provided with a standard tenon 7 projecting from the distal end thereof. FIG. 6A shows a partial transparent view of the third adaptor 300 positioned on the tenon 7. FIG. 6B presents an exploded view. FIGS. 6C-6G are a top perspective, bottom perspective, front view, top view and bottom view respectively of a body 302 of the third adaptor 300. In the illustrated embodiment, the third adaptor 300 is cast from a strong lightweight material, such as aluminum, into a generally hollow unitary body 302. Like the first and second adaptors 100, 200, the third adaptor 300 may have a longitudinal axis A passing through the third adaptor along the length thereof. The body 302 forms a peripheral wall having an exterior surface 312 and an interior surface 314. The peripheral wall may be understood as being substantially a square tube such that a profile of the exterior surface 312 has four flat sides to mirror the outside of a square pole 3.

The third adaptor 300 may have several features similar to the first and second adaptors 100, 200, including at least one wiring aperture 316, at least one bracket aperture 318, and at least one mounting aperture 320. The at least one wiring aperture 316 may be formed through the body 302 and configured as a conduit for passing wiring from the pole 3 to the light fixture 10. In one embodiment, the third adaptor 300 comprises four wiring apertures 316, one on each respective side of the square profile. The at least one bracket aperture 318 may be formed adjacent to a respective wiring aperture 316 for use when securing a mounting bracket 24 to the third adaptor 300. The at least one mounting aperture 320 may be formed through the peripheral wall and configured to receive a set screw 322 to secure the third adaptor 300 to the tenon 7. The mounting apertures 320 may be provided through chamfered corners 324 formed in the body 302 near the bottom end thereof. Further, a cap 360 may be provided on the top of the body 302.

The interior surface 314 of the third adaptor 300 is configured specifically to provide a close fit over a standard tenon 7 that is 2 and ⅜ inches in outside diameter. A close fit is provided when the interior surface 314 is capable of sliding closely over a standard 2 and ⅜ inch tenon 7 with minimal clearance. As a result, the longitudinal axis A is maintained parallel with a longitudinal axis of the pole 3 when the third adaptor 300 is fully seated on the tenon 7 as a force is applied to the sides of the third adaptor 300. Collectively, the interior surfaces 314 may be curved to follow a circle, providing an interior diameter of 2 and ½ inches. In this embodiment, a close fit with minimal clearance works out to be about 1/16 inch on each side. In one embodiment, the body 302 has a plurality of protrusions 330 extending inwardly from the peripheral wall to form the portion of the interior surface 314 that provides the close fit over the tenon 7. In some embodiments, the protrusions 330 do not extend a full length of the body 302. In some embodiments, an interior face 332 of each protrusion 330 is curved.

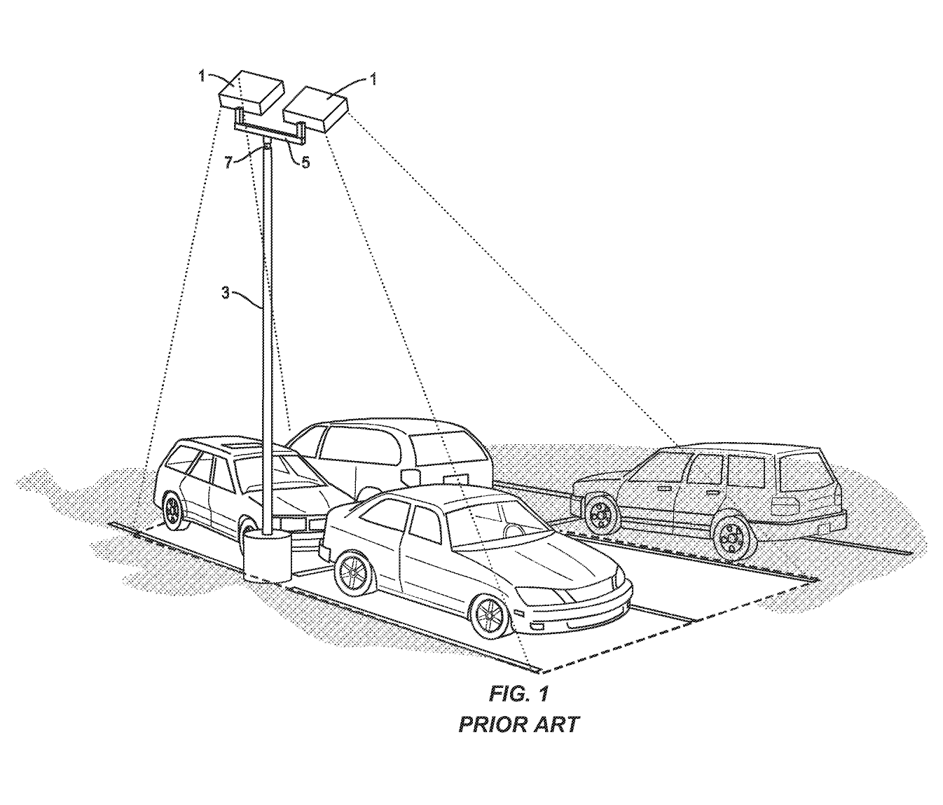

Use of the system of the present disclosure may be described in terms of a set of method steps performed to retrofit an existing light pole 3 and light fixture 1 as shown in FIG. 1 with an energy efficient light fixture 10. The method may include removing any existing light fixture 1 and selecting an appropriate adaptor 100, 200, 300. The step of selecting an appropriate adaptor may include selecting a first adaptor 100 when the light pole 3 comprises a round base and no tenon, selecting a second adaptor 200 when the light pole 3 comprises a round base and a tenon 7, and selecting a third adaptor 300 when the light pole 3 comprises a square base and a tenon 7. The method may further comprise mounting the selected adaptor of the first, second and third adaptors to the top of the light pole 3 and installing an LED light fixture 10 upon the selected adaptor 100, 200, 300. In some embodiments, the method may also include attaching at least one mounting bracket 24 to an exterior of the selecting adaptor 100, 200, 300 and wherein the step of installing comprises hanging the LED light fixture 10 on the mounting bracket 24.

Other embodiments according to the present disclosure may be described in terms of the following paragraphs:

Paragraph 1. An adaptor for a light pole tenon, comprising:

a hollow unitary body having a peripheral wall extending from a top of the body to a bottom of the body along a longitudinal axis, the peripheral wall having an interior surface and an exterior surface,

at least one wiring aperture formed through the peripheral wall configured as a conduit for wiring;

at least one mounting aperture formed through the peripheral wall configured to receive a fastener to secure the adaptor to the tenon,

wherein at least a portion of the interior surface provides a close fit over the tenon.

Paragraph 2. The adaptor of Paragraph 1, wherein the peripheral wall is substantially cylindrical and a profile of the exterior surface is circular.

Paragraph 3. The adaptor of Paragraph 2, comprising three wiring apertures spaced at 120 degree intervals around the longitudinal axis.

Paragraph 4. The adaptor of Paragraph 1, wherein the peripheral wall is substantially a square tube and a profile of the exterior surface is substantially square, and the adaptor comprises a wiring aperture on each of the four sides of the square.

Paragraph 5. The adaptor of Paragraph 1, wherein the body comprises a plurality of protrusions extending inwardly from the peripheral wall to form the portion of the interior surface that provides the close fit over the tenon.

Paragraph 6. The adaptor of Paragraph 5, wherein the protrusions do not extend a full length of the body.

Although the above disclosure has been presented in the context of exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

1. A system for retrofitting an existing light pole, the system comprising:
at least one LED light fixture;
at least one connector; and
an adaptor configured to be mounted to the top of the existing light pole,
wherein the adaptor is a first adaptor when the existing light pole has a round base and no tenon,
wherein the adaptor is a second adaptor when the existing light pole comprises a round base and a tenon,
wherein the adaptor is a third adaptor when the existing light pole comprises a square base and a tenon,
wherein the first adaptor, the second adaptor and the third adaptor each have a different configuration.

2. The system of claim 1, wherein the first adaptor comprises:
a round tube having an interior surface, an exterior surface and a longitudinal axis extending along the length of the tube;
a stopper bracket mounted on the interior surface of the tube, the stopper bracket including an annular portion disposed with an opening of the annular portion substantially perpendicular to the longitudinal axis, wherein the annular portion is disposed along the longitudinal axis to abut a distal end of the existing light pole; and
at least one first wiring aperture provided through the round tube at a position above the annular portion.

3. The system of claim 2, wherein the stopper bracket includes an attachment portion extending from the annular portion substantially parallel with the longitudinal axis, the attachment portion configured to connect the annular portion to the tube.

4. The system of claim 3, wherein the attachment portion has a second wiring aperture, wherein the second wiring aperture is configured to be aligned with the first wiring aperture.

5. The system of claim 1, wherein the first adaptor further comprises a bottom cover provided on the bottom of the tube to cover a gap between the interior surface of the tube and an outer diameter of the existing pole.

6. The system of claim 5, wherein the tube comprises at least one first mounting aperture configured to receive a fastener to secure the third adaptor to the pole, and
wherein the bottom cover has a mounting portion extending substantially parallel with the longitudinal axis, the mounting portion having at least one second mounting aperture configured to align with a corresponding first mounting aperture such that the fastener also maintains the bottom cover relative to the tube.

7. The system of claim 1, wherein the second adaptor comprises:
a hollow unitary body having a peripheral wall extending from a top of the body to a bottom of the body along a longitudinal axis, the peripheral wall having an interior surface and an exterior surface,
at least one wiring aperture formed through the peripheral wall configured as a conduit for wiring;
at least one mounting aperture formed through the peripheral wall configured to receive a fastener to secure the adaptor to the tenon,
wherein at least a portion of the interior surface provides a close fit over the tenon,
wherein the peripheral wall is substantially cylindrical and a profile of the exterior surface is circular.

8. The system of claim 7, wherein the second adaptor comprises three wiring apertures spaced at 120 degree intervals around the longitudinal axis.

9. The system of claim 7, wherein the body comprises a plurality of protrusions extending inwardly from the peripheral wall to form the portion of the interior surface that provides the close fit over the tenon.

10. The system of claim 9, wherein the protrusions do not extend a full length of the body.

11. The system of claim 1, wherein the third adaptor comprises:
a hollow unitary body having a peripheral wall extending from a top of the body to a bottom of the body along a longitudinal axis, the peripheral wall having an interior surface and an exterior surface,
at least one wiring aperture formed through the peripheral wall configured as a conduit for wiring;
at least one mounting aperture formed through the peripheral wall configured to receive a fastener to secure the adaptor to the tenon,
wherein at least a portion of the interior surface provides a close fit over the tenon,
wherein the peripheral wall is substantially a square tube and a profile of the exterior surface is substantially square, and the adaptor comprises a wiring aperture on each of the four sides of the square.

12. The system of claim 11, wherein the body comprises a plurality of protrusions extending inwardly from the peripheral wall to form the portion of the interior surface that provides the close fit over the tenon.

13. The system of claim 12, wherein the protrusions do not extend a full length of the body.

14. An adaptor for mounting at least one light fixture upon a pole, the adaptor comprising:
a tube having an interior surface, an exterior surface and a longitudinal axis extending along the length of the tube;
a stopper bracket mounted on the interior surface of the tube, the stopper bracket including an annular portion disposed with an opening of the annular portion substantially perpendicular to the longitudinal axis, wherein the annular portion is disposed along the longitudinal axis to abut a distal end of the existing light pole; and
at least one first wiring aperture provided through the tube at a position above the annular portion.

15. The adaptor of claim 14, wherein the stopper bracket includes an attachment portion extending from the annular portion substantially parallel with the longitudinal axis, the attachment portion configured to connect the annular portion to the tube.

16. The adaptor of claim 15, wherein the attachment portion has a second wiring aperture, wherein the second wiring aperture is configured to be aligned with the first wiring aperture.

17. The system of claim 14, wherein the third adaptor further comprises a bottom cover provided on the bottom of the tube to cover a gap between the interior surface of the tube and an outer diameter of the existing pole.

18. The system of claim 17, wherein the tube comprises at least one first mounting aperture configured to receive a fastener to secure the third adaptor to the pole, and
wherein the bottom cover has a mounting portion extending substantially parallel with the longitudinal axis, the mounting portion having at least one second mounting aperture configured to align with a corresponding first mounting aperture such that the fastener also maintains the bottom cover relative to the tube.

19. A method of retrofitting a light pole, comprising:
removing an existing light fixture;
selecting a first adaptor when the light pole comprises a round base and no tenon;
selecting a second adaptor when the light pole comprises a round base and a tenon;
selecting a third adaptor when the light pole comprises a square base and a tenon;
mounting the selected adaptor of the first, second and third adaptors to the top of the light pole;
installing an LED light fixture upon the selected adaptor.

20. The method of claim 19, further comprising:
attaching at least one mounting bracket to an exterior of the selected adaptor, wherein the step of installing comprises hanging the LED light fixture on the mounting bracket.
